(19) United States
(12) Patent Application Publication
(10) Pub. No.: US 2014/0280850 A1
(43) Pub. Date: Sep. 18, 2014

(54) Collaborative State Machine Management

(71) Applicant: David L. Wagstaff, Lake Forest, CA (US)

(72) Inventor: David L. Wagstaff, Lake Forest, CA (US)

(73) Assignee: Lantronix, Inc., Irvine, CA (US)

(21) Appl. No.: 14/214,342

(22) Filed: Mar. 14, 2014

Related U.S. Application Data
(60) Provisional application No. 61/799,044, filed on Mar. 15, 2013.

(51) Int. Cl. H04L 12/24

(52) U.S. Cl. CPC H04L 41/02
USPC 709/223

(57) ABSTRACT

An engine within a system capable of instantiating a state machine used to monitor an associated legacy device. The engine can instantiate state machine variables related to desired characteristics and derive values for the variables based on an analog signal received from the legacy device. In order to cause the state machine to transition to a new state, the engine must obtain information from a different engine to complete the necessary transition criteria.

### CROSS REFERENCE TO RELATED APPLICATION

The present application claims priority to U.S. Provisional Application No. 61/799,044, filed Mar. 15, 2013 and titled “Collaborative State Machine Management,” which is incorporated in its entirety herein.

### FIELD OF THE INVENTION

The field of the invention is state machine management technologies.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

State machines can be used for multiple purposes including reporting a status of a monitored device and, based on input or the meeting of certain criteria, change the state of the monitored device from the current state to a new state. The rules governing a state machine are often limited to data sources available to the state machine at the time the state machine is designed. Unfortunately, this approach limits the adaptability of the state machine for future purposes to only states and conditions that use those original data sources.

Others have put forth effort towards developing state machines usable for specific applications.

U.S. Pat. No. 7,716,610 to Challenger, et al (“Challenger”) titled “Distributable and Serializable Finite State Machine”, issued May 11, 2010, discusses the use of time- and space-shifted instances of a finite state machine (FSM). The specification for the generation of the FSM is user-generated or pre-defined. Each instance of the FSM is a separately-executing process. Because the states and transitions of the FSM are part of the FSM specification, all instances initiated from the FSM specification share the same states and transitions. Challenger does not discuss generating customizable state machines (or instances) from classes of variables or generating instances of state machines where the instances may have unique states and transitions.

U.S. Pat. No. 7,039,893 B2 to DenBraber discusses a configurable finite state machine where configuration data can be applied to a generic state machine, producing a configuration-based state machine implementation. DenBraber does not discuss requesting additional data from an external source in supplementing or completing the data necessary for the implementation of transitions within a state machine.

Thus, there is still a need for an adaptable device having the flexibility to creating adaptable state machines capable of being used with a variety of legacy devices and customizable according to a user's requirements, the state machines having the ability to request information as necessary.

### SUMMARY OF THE INVENTION

The inventive subject matter provides apparatus, systems and methods in which one or more apparatuses can interact with each other and with one or more separate devices.

Legacy devices may include state machines in which a state of the device is provided about the device. Legacy devices can include vending machines, ATMs, turnstiles, utility meters, thermostats, electrical systems, or other devices. For example, vending machines may include states of temperature, weight, etc., while turnstiles may include states about whether the turnstile is locked or open. These devices may have one or more sensor to detect one or more attribute of the device state. That information may be used to change the state of the device from its current state to a new state. For example, if a vending machine temperature is too high, the device may engage an air conditioning or refrigeration unit to cool the interior space. The state information may be available external to the device through a communication interface.

A problem may arise when these legacy devices can no longer communicate with other systems or devices because the protocol and/or port interface of the legacy device is no longer compatible. Moreover, information from the legacy device may be inefficiently used, where the state transitions are not managed properly, or where the definition of the state transitions should be changed. Flexibility is desired to change the legacy device state based on the information already received by the legacy device or from information the legacy device did not obtain or previously use to transition or monitor a state.

Accordingly, embodiments of the present apparatus may be used to interface between the legacy device and other apparatus, servers, networks, legacy devices, or other computing devices. The apparatus according to exemplary embodiments accordingly has a non-transitory computer-readable memory (RAM, flash, ROM, hard drive, solid state drive, etc.), at least one processor coupled with that memory, and at least one communication interface configured to communicatively couple with one or more other apparatuses and at least one separate device. The separate device can include, for example, other computing devices (e.g., servers, clients, etc.) and legacy devices (e.g., vending machines, ATMs, medical devices, etc.). The non-transitory computer-readable memory can store instructions that, when executed by the at least one processor, cause the processor to carry out the steps and functions of the invention.

One or more of the at least one communication interface can be an analog interface. For example, the apparatus can comprise a first analog input. In an embodiment, the apparatus can further comprise at least one additional analog input. In an embodiment, the apparatus can further comprise at least one analog output. The at least one communication interface can be configured to communicate to the legacy device.

To this end, in an exemplary embodiment, an apparatus comprising: a first analog input; a memory; a communication interface; a state management engine coupled with the first analog input, the memory, and the communication interface, the state management engine programmed to: obtain a state machine definition via the communication interface, the state machine definition comprising state variable class definitions; instantiate a state machine according to the state machine definition; instantiate at least one state variable in the memory according to the state variable class definition; derive a state variable value for the at least one state variable as a function of a first analog signal received via the first analog input; determine state transition criteria from a current state of the state machine to at least one permitted alternate state of the state machine based on the state variable value and the state machine definition; construct a decision point discovery message based on the state transition criteria; transmit the decision point discovery message to at least one other state management engine; receive a discovery response message from the at least one other state management engine, the discovery, response message comprising additional state variable values; and select a next state from the at least one permitted state as a function of the additional state variable values and the state transition criteria; and cause the state machine to transition from the current state to the next state.

In an exemplary embodiment, further comprising a second analog input.

In an exemplary embodiment, wherein the state management engine is further programmed to further derive the state variable value as a function of a second analog signal received via the second analog input.

In an exemplary embodiment, wherein the communication interface comprises a network interface.

In an exemplary embodiment, wherein the network interface includes at least one of the following: an Ethernet interface, a wireless interface, and a cellular interface.

In an exemplary embodiment, wherein the state management engine is further programmed to transmit the decision point discovery message via the communication interface and external to the apparatus, to the at least one other state management engine.

In an exemplary embodiment, wherein the state machine definition includes state-specific event criteria.

In an exemplary embodiment, wherein the state management engine is further configured to transmit an event notification as a function of the state-specific event criteria.

In an exemplary embodiment, wherein the at least one other state management engine comprises a second state management engine disposed in the apparatus.

In an exemplary embodiment, further comprising at least one analog output.

In an exemplary embodiment, further comprising at least two analog outputs.

In an exemplary embodiment, further comprising a relay output.

In an exemplary embodiment, wherein the state variable value comprises a representation of ambient data.

In an exemplary embodiment, wherein the decision point discovery message comprises a contract discovery.

In an exemplary embodiment, wherein the discovery response message further comprises a contract.

In an exemplary embodiment, further comprising a contract enforcement engine programmed to authorize the state management engine and the at least one other management engine to engage according to their respective contracts.

In an exemplary embodiment, wherein the contract enforcement engine is disposed within the apparatus.

In an exemplary embodiment, wherein the discovery response message comprises a discovery redirect message.

In an exemplary embodiment, wherein the discovery response message includes an identifier of an internal data source of the apparatus.

In an exemplary embodiment, wherein the discovery response message further comprises at least one of the following: a second state variable value, an SNMP MIB, a register, a digital value of the analog signal, and a file in the memory.

In an exemplary embodiment, wherein the discovery response message further comprises a decision point identifier.

In an exemplary embodiment, wherein the decision point identifier designates a state transition decision arbitrator.

In an exemplary embodiment, wherein the decision point identifier designates a migrateable state transition arbitrator.

In an exemplary embodiment, wherein the state management engine is further programmed to receive the additional state variable values from the state transition decision arbitrator.

Embodiments as used herein may be used to monitor or determine a state of the attached legacy device. In addition or alternatively thereto, the apparatus may be used to define or modify the state or the transition criteria between states or communicate any combination of information to another device, apparatus, or network. Thus, embodiments as described herein may be used to upgrade the interface of legacy device; expand the communication and monitoring potential to and/or from the legacy device; change, create, or control the transition criteria of the legacy device; or modify other features of the legacy device.

The apparatus can also comprise a state machine engine. The state machine engine can be coupled with the first analog input, the memory and the communication interface. The state machine engine can be configured to obtain a state machine definition via the communication interface, the state machine definition comprising state variable class definitions. The state machine definition includes the information necessary to instantiate the state machine. This information can include the definitions of the states within the state machine and transitions that effect a change from one state to another. The state variable class definitions can be the collection or group of categories of variables that will be used within the instantiated state machine.

The machine engine can further be configured to instantiate a state machine according to the state machine definition and instantiate at least one state variable according to the state variable class definitions. In an embodiment, the state machine definition can include state-specific event criteria.

The state machine engine can be further configured to use a first analog signal received via the first analog input to derive a state variable value for the at least one state variable. In an embodiment, the state variable value can be a representation of ambient data. The ambient data can be data corresponding to external conditions. For example, the ambient data can be data from external sources or sensors such as GPS data, data from accelerometers, temperature data, etc.

Having the derived state variable value and obtained state machine definition, the state machine engine can be further configured to determine state transition criteria. The state transition criteria can be the criteria used to govern a transition from the current state of the state machine to at least one permitted alternative state of the state machine. The state transition criteria can also be the criteria used to determine what permitted alternate states (if any) exist.

The state machine engine can further be configured to construct a decision point discovery message based on the state transition criteria and transmit the message to at least one other state machine engine. The decision point discovery message can, for example, be a message requesting additional information from other state machine engines necessary in the determination of whether to transition to a new state (and if so, which permitted alternative state). In an embodiment, the decision point discovery message can be a contract discovery.

In some embodiments, the at least one other state machine engine can be one or more separate engines within the same apparatus. In an embodiment, the at least one state machine engine can be one or more separate engines residing in one or more separate devices external to the apparatus. The separate devices may be at least one other apparatus.

The state machine engine can be further configured to receive a discovery response message from the at least one other state machine engine. The discovery response message can include additional state variable values that might not a prior be available to the instant state machine. In some embodiments, the discovery response message can be a contract. In an embodiment, the discovery response message can be a discovery redirect message. In an embodiment, the discovery response message can include an identifier of an internal data source of the apparatus. In an embodiment, the discovery response message can be a second state variable value, an SNMP MIB, a register, a digital value of the analog signal or a file in the memory. In an embodiment, the discovery response message can be a decision point identifier. In an embodiment, the decision point identifier can designate a state transition arbitrator. In an embodiment, the state transition arbitrator can be a migrateable state transition arbitrator.

In an embodiment, the apparatus can include a contract enforcement engine that authorizes the state management engine and the at least one other state management engine to engage according to their respective contracts. In an embodiment, the contract enforcement engine can be disposed within the apparatus.

The state machine engine can be further configured to select the next state from the available permitted states based on the additional state variable values and the state transition criteria and then cause the state machine state machine to transition from the current state to the next state.

In an embodiment, the communication interface can be a network interface. Examples of a suitable network interface include an Ethernet interface, a wireless interface and a cellular interface.

In an embodiment, the state management engine can be further configured to transmit an event notification based on the state-specific event criteria.

In an embodiment, the apparatus can further comprise a relay output.

In an embodiment, the state management engine can be further configured to receive additional state variable values from the state transition decision arbitrator.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 provides an overview of the system of the invention.

FIGS. 2A-2C illustrates an exemplary apparatus comprising an embedded module that can be integrated within a legacy device. FIG. 2A is a perspective view, FIG. 2B is a side view, and FIG. 3C is an end view of the exemplary apparatus. FIG. 2D is an exemplary block diagram of an exemplary hardware and software configuration of the exemplary apparatus of 2A-2C.

FIG. 3A illustrates an exemplary apparatus separate from the legacy device communicatively coupled by a communication interface such as the legacy communication interface. FIG. 3B illustrates an exemplary application of the apparatus of FIG. 3A used within a legacy device of a liquid tank.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate that computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including exchanging signals between a device and other devices, enabling the device to change states based on analog signals communicated to or from a legacy device.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

FIG. 1 provides an overview of the system as an example embodiment of the invention.

The system depicted in FIG. 1 includes an apparatus 2 communicatively coupled with a legacy device 4 via a legacy communication interface 6 on the apparatus 2. The apparatus is also connected to other apparatuses, as well as other computing devices, via a communication interface 8 on the apparatus 2. The other computing devices can be client devices used by users having an interest in the function of the legacy device and to access reports associated with the function of the invention.

The legacy communication interface 6 can be an analog communication interface (i.e., an analog output). The communication interface 8 can include wireless interfaces, Ethernet interfaces, RS-232 interfaces, cellular interfaces, USB, 802.11, WiMAX, Zigbee, Bluetooth, or any other communication interfaces enabling the exchange of data.

The legacy device 4 can be a device that can provide information regarding its state operation in the form of one or more analog signals. For example, in an exemplary embodiment, the legacy device is a state machine. The information regarding the state machine's state of operation can be information gathered by one or more sensors within the legacy device. For example, the information can include temperature information, flow information, information related to the current position of mechanical components, weight information, etc. The legacy device/state machine can be a device that can report the analog information as states on a limited basis or, alternatively, that cannot translate the analog information into state information at all. Legacy devices/state machines can include vending machines, ATMs, turnstiles, utility meters, thermostats, electrical systems, or other devices. The legacy device/state machine can be configured to output analog signals via an analog output.

In some embodiments, the apparatus can be integral to the state machine. For example, FIG. 2 illustrates an exemplary apparatus that could comprise an embedded module that can be readily integrated within a legacy device design. An example of an embedded module that could be suitably adapted for use as the apparatus includes the Lantronix® X-Port® (see URL www.lantronix.com/device-networking/embedded-device-servers/xport.html). In other embodiments, for example as illustrated in FIG. 3, the apparatus and the state machine are separate devices communicatively coupled by a communication interface such as the legacy communication interface, which can include one or more analog interfaces. An example external device that can be adapted for use with the inventive subject matter includes the Lantronix® xSenso™ device (see URL www.lantronix.com/device-networking/external-device-servers/xsenso.html). In either case, the apparatus may comprise a housing enclosing the state management engine and interfacing between the legacy device and other devices or networks through the legacy communication interface and/or the communication interface.

An exemplary embedded module, as illustrated in FIGS. 2A-2D, may include a compact, integrated solution to web-enable any device with serial capability. The exemplary embodiment provides the design of network connectivity by including all of the required hardware and software inside a single embedded solution. Network features may include 10 Base-T/TX Ethernet connection, proven operating system, an embedded web server, e-mail alerts, a full TCP/IP protocol stack, and 256-bit AES encryption for secure communications. The device include a network processor system on a chip, which includes a 10/100 MAC/PHY and 256 KB of SRAM. The built-in web server provides communication with a device via a standard internet browser. The web capability can be used for remote configuration, real-time monitoring or troubleshooting. The device may include 512 KB of on-module Flash for web pages and software upgrades.

An exemplary external device, as illustrated in FIGS. 3A-3B, may be a compact DIN-rail or wall mount solution that enables analog sensors, such as voltage and/or current) to easily and transparently send real-time data to any node on the Internet or to a cloud based application. The device includes options of two analog outputs (voltage or current) or two mechanical relays (AC or DC). The device is compatible with many data acquisition systems to permit remote monitoring and data logging of critical events in process control and automation applications. For example, the device may be configured to send alarms via email when the analog I/O readings are outside predefined ranges. These alarms allow control engineers to take immediate corrective action when certain thresholds are met. Exemplary sensors the device couples to include temperature, humidity, pressure, flow, level, force, weight, gas/air quality, among others. The device may include one or more of the following components: two isolated analog voltage/current inputs, two isolated analog voltage/current outputs or two mechanical relays, redundant input power, power excitation per input, Ethernet port for communication, USB port for configuration. The device may support one or more of the following features: ModbusTCP protocol; web based monitoring, charting and data logging; HTTP.POST to cloud based applications; email and text message alert notification; and authentication, up to 256-bit encryption, SSL, SSH.

The apparatus can include a memory, at least one legacy communication interface, at least one communication interface and a processor. The memory of the device is configured to store instructions and data used by the processor to execute the functions and processes of the invention.

The at least one legacy communication interface can include one or more analog inputs. The analog input can be communicatively coupled with the state machine and configured to receive analog signals from the state machine. Further, the apparatus can include one or more analog-to-digital converters that covert received analog signals from the state machine to a digital value. For example, the analog-to-digital converter could convert electrical signals to a scaled range of 0 to 65,535 (i.e., a 16 bit unsigned integer), and possibly account for offset values.

The apparatus can further include at least one or more analog outputs, relay outputs, or other outputs. For example, a relay output can be used to toggle power on the state machine if desired.

The apparatus can also include a state management engine 10. In an embodiment, the state management engine 10 can include one or more software modules stored within the memory of the apparatus, and executed by the processor of the apparatus to carry out the functions described herein. The functions of the state management engine are described in detail below. In an embodiment, the state management engine can be dedicated hardware, such as a computing device having memory and a processor, programmed to carry out the functions described herein. For example, the state management engine could operate within an operating systems (e.g., uCLinux, Linux, VRTX, RTOS, etc.) and executing on an processor (e.g., ARM, ColdFire, etc.), even a multi-core processor.

In an embodiment, the apparatus can include a contract enforcement engine. The contract enforcement engine authorizes a state management engine of an apparatus and one or more state management engines (which may be within the same apparatus or external to the apparatus) to engage according to their respective contracts. The contract enforcement engine can be software instructions stored in the memory of the apparatus and executed by the processor of the apparatus. In an embodiment, the contract enforcement engine can be a hardware computing device within the apparatus, the hardware computing device containing its own memory and processor, and programmed to carry out the described functions. In an embodiment, the contract enforcement engine can be a computing device external to the apparatus that is programmed to carry out the described functions. As used herein the term “contract” is used to mean a code contract that allow internal and external software modules to conduct run-time checking of acceptable pre-conditions, post-conditions, or other aspects of module to module interactions. An example implementation of a contract with respect to .NET can be found at the URL research.microsoft.com/en-us/projects/contracts. Within the scope of this document a contract is consider to be applied to inter-state engine interactions, inter-apparatus interactions (e.g., M2M, P2P, etc.), or other apparatus-to-external device interactions.

The state management engine 10 can be configured to obtain a state machine definition via the communication interface 8. The state machine definition includes the information necessary to instantiate the state machine. This information can include the definitions of the states within the state machine and transitions that effect a change from one state to another. The state machine definition can be unique, specific or related to one or more characteristics. For example, the characteristic can include one or more of an instance, one or more users, one or more client devices, an environment, the legacy device, a business, product or service associated with the legacy device or a function of the legacy device. The characteristic can also encompass grouping of the legacy device with other legacy devices.

For example, if the legacy device is a vending machine, the state machine definitions could be related to maintenance of the vending machine or to inventory management. The state machine definition could take the form of a serialized file (e.g., JSON, XML, etc.), a script (e.g., JavaScript, Python, Perl, Ruby, etc.), a binary file, or other file format.

The state machine definition also includes state variable class definitions. The state variable class definitions can be the collection or group of categories of variables that will be used within the instantiated state machine. One or more state variables can be instantiated in the memory from the state variable class definitions. The categories of variables can include categories of variables whose values can be determined from signals received from the legacy device/state machine and can also include categories of variables whose values are obtained from sources external to the legacy device/state machine.

In an embodiment, the state machine definition can include information regarding the designation of a decision point. For example, the decision point designation information can include information such as a communication address or a hardware or software identifier that indicates an electronic location of the designated decision point.

Continuing with the example of the legacy device as state machine of a vending machine, state variable class definitions can include the group of variables related to maintenance. The variables themselves could be related to the temperature of the machine, power readings, liquid flow rates, etc. For inventory control, the variables could be related to sensor readings related to the weight of product (which may indicate how much product remains). The state variable class definition for one function (such as maintenance) can include categories of variables that are also used in state variable class definitions for other functions (such as inventory control), and can also include categories of variables unique to that function. In an embodiment, the state variable class definitions can be a type of object. In this embodiment, the state variables are the instantiated objects themselves.

The state variable value can be a value derived for a specific state variable. The state variable value can be derived as a function of one or more analog signals received via one or more of the analog inputs. The derived value can be customized according to the requirements of the state machine. For example, the value can be a standard value corresponding to an analog signal (e.g., a temperature value in Celsius, Fahrenheit, Kelvin, etc. for an analog signal received from a temperature sensor), the can be an assigned value corresponding to a range of analog signals, where value can correspond to the analog signal falling within a designated range for that particular signal (e.g., a temperature value is assigned corresponding to the analog signal from a temperature sensor falls within a designated temperature range) or the value can correspond to the analog signal relative to a baseline (e.g., the value as a percentage corresponding to the efficiency of a component within the device when the received analog signal is compared to a baseline representing the optimal functional state of the component, or the value).

As the state machine monitors the state variable values, the state machine might be required to change from a current state to a next state depending on transition criteria. The state transition criteria can be a set of conditions required to effect a transition from the current state of the state machine to at least one of the permitted alternate states. The state transition criteria can be determined based on one or more state variable values and the state machine definition. Because the state transition criteria can be based on the state variable values and the state machine definition, the state transition criteria can also determine one or more permitted alternate states for the particular state machine from all possible alternate states. The state transition criteria can be predicated on the mere existence of one or more state variable values (i.e. the specific value itself is not required, and may be a null value) or can be based on the specific value of the state variable value. In an embodiment, the state transition criteria can be an object.

Because the state machine definition can include categories of state variables or other information whose values may be unobtainable via the analog inputs (e.g., the legacy device is incapable of obtaining data in those categories or outputting the data via the available communication interfaces), the state transition criteria can require state variable values that the state management engine is incapable of deriving or otherwise obtaining internally. In this situation, the state management engine can attempt to see additional information that is otherwise not available to the active state machine. Thus, the state management engine can construct a decision point discovery message based on the state transition criteria to request any information required by the state transition criteria to select the next state and cause a change to the next state.

A decision point can be considered another entity (e.g., another state machine, another apparatus, an external device, etc.) capable of providing additional information to aid in the decision process of determining which of the permitted states should be the next state. The decision point can be an authority that instructs the state machine to transition state, or a supporting device that simply provides additional information.

The decision point discovery message is transmitted by the state management engine to one or more other state management engines. As indicated above, the apparatus can contain more than one state management engine. Therefore, the decision point discovery message can be sent to other state management engines within the same apparatus. In an embodiment, the decision point discovery message can be a contract discovery.

A discovery response message is a message received by the state management engine from at least one other state management engine or decision point. The discovery response message includes data capable of aiding in the selection of the next state, and to cause the transition to the next state. The discovery response message can include additional state variable values corresponding to the state variables whose values the state management engine is unable to obtain from the analog inputs. In an embodiment, the additional state variable values can be NULL, indicating no information is available.

In an embodiment, the transmission of discovery response messages are not required to be in response to a decision point discovery message. One or more of the state management engines or decision points within a network can be configured to periodically broadcast data to the other members of the network. In an embodiment, the discovery response message can include at least one of a second state variable value, an SNMP MIB, a register, a digital value of the analog signal, and a file in memory. In an embodiment, the discovery response message can be a contract, or a discovery redirect message. The discovery redirect message may include an indication of where the information sought in the decision point discovery message can be found. The indication can include at least one of a pointer, a communication address, a link, a device identifier, or a memory location. The discovery response message may be any one or a combination of the exemplary responses. For example, the discovery response message can be an identifier of an internal data source of the apparatus, or can include a decision point identifier, where the decision point identifier designates a decision point.

The decision point can coordinate and manage the transitions of one or more state machines operating on one or more state management engines within a network. The decision point can be the point of authority within the network, and can act as the sole provider of information in response to requests sent by one or more state management engines within the network. The requests can be redirected decision point discovery requests. The decision point can respond to requests for information from each state management engine individually. In other words, the decision point can respond only with information available to itself and only information relevant to the individual requesting state management engine,

The decision point can decide how to respond to requests for information from one or more state management engines based on conditions related to the network as a whole. The decision point can survey the status of the network (e.g., condition of the communication interfaces, the number of active engines/apparatuses/clients in the network at a given time/characteristics of legacy devices in the network, etc.) or the status of the one or more state management engines within the network (e.g., the state machines active on the one or more state management engines, the types of data requested by the one or more state management engines, etc.). This approach allows for the synchronization and coordination of the various apparatuses (and their respective state management engines and state machines). For example, in the vending machine example from above, comparing the status received from multiple apparatuses regarding the state of multiple vending machines can help diagnose malfunctioning units (e.g., if the data from a particular state management machine diverges unusually from the rest of the data from the remaining state management machines). In another example, comparing the states of the vending machines can help optimize vending machine location to take advantage of high-traffic locations and avoid overlap.

In an embodiment, the decision point can generate responses to send to one or more of the state management engines. The response sent from the decision point to the state management engine can be a discovery response message, and can include additional state variable values. The discovery response message from the decision point can include a command to transition to a particular state.

A decision point can be designated according to one or more of a variety of factors (e.g., user-designated, relative location of the state management engine within the network, computing capacity of the apparatus, location of the legacy device, type of legacy device, configuration of legacy device, relative importance of legacy device, network communication interface characteristics, etc.). In an embodiment, the designation of a decision point can be static (i.e., once the decision point is designated for a particular network, the designation does not change). In an embodiment, the designation of a decision point can be dynamic (i.e., the decision point can change based on rules or conditions).

In an embodiment, the designation described above can be repeated periodically. If one or more of the factors used in the designation has changed, the change can result in the designation of a new decision point. A change to one of the factors can trigger the execution of the designation process. In an embodiment, a change in the network environment (e.g., addition or removal of state management engines, apparatuses, legacy devices or other devices to the network or a change to the communication interface) can trigger the execution of the designation process.

In an embodiment, the decision point can be one of the state management engines within the network, or a separate processor or other hardware component within an apparatus programmed to carry out the functions of a decision point. The decision point can be a software module programmed to carry out the functions of a decision point, executed by the processor of the apparatus. The decision point software module can be independent of any state management engine within the apparatus. The decision point can be a computing device communicatively coupled to one or more state management engines within the network. The computing device includes a processor programmed to carry out the functions of the decision point. The computing device can be a decision point server.

In an embodiment, the designated decision point can be a state transition decision arbitrator. The state transition decision arbitrator can be a software agent configured to perform the functions of the decision point. The state transition decision arbitrator can be stored in the memory of an apparatus, and executed by the processor of the apparatus. The state transition decision arbitrator can be hosted within a state management engine or function independently of any state management engine. In an embodiment, the state transition decision arbitrator is capable of migrating from one host to another. The migration of the state transition decision arbitrator can be analogous to the dynamic decision point designation described above.

In one embodiment, one or more of the derived state variable values can be used to instantiate the state machine. In this embodiment, the state management engine obtains the state variable class definitions. The state machine definition does not include the states and transitions used to instantiate the state machine. The state management engine uses the obtained state variable class definition to instantiate one or more state variables.

The group of one or more instantiated state variables may be compared against entries of reference state variable groups stored in a database. Each of the reference state variable group entries in the database corresponds to a particular state machine, including the state machine definition for that state machine. When a match is found to a desired degree of similarity, the corresponding state machine definition (i.e. states, transitions and any additional information required to instantiate the state machine) is obtained by the state management engine. The state management engine then instantiates the state machine according to the obtained state machine definition. The remaining aspects of the invention mirror those of the embodiments described above.

In an embodiment, the state management engine derives state variable values for each of the one or more instantiated state variables. The group of derived state variable values is then compared against entries of reference state variable values stored in a database. Each of the reference state variable value group entries in the database corresponds to a particular state or transition of a particular state machine. The database entry also includes the state machine definition for that state machine. When a match is found to a desired degree of similarity, the corresponding state machine definition (i.e., states, transitions and any additional information required to instantiate the state machine) is obtained by the state management engine. The state management engine then instantiates the state machine according to the obtained state machine definition. The remaining aspects of the invention mirror those of the embodiments described above.

The database may be stored in memory within the apparatus or may be stored externally (e.g., a server or other external memory accessible via a computing device). The comparison may be performed by the state management engine or another hardware or software module programmed to perform the comparison within the apparatus. In an embodiment, the comparison may be performed by a processing device (i.e. computing device having a processor) external to the apparatus.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C and N, the text should be interpreted as requiring only one element from the group, not A plus N, or B plus N, etc.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

What is claimed is:

1. An apparatus comprising
a first analog input;
a memory;
a communication interface;
a state management engine coupled with the first analog input, the memory, and the communication interface, the state management engine programmed to:
obtain a state machine definition via the communication interface, the state machine definition comprising state variable class definitions; instantiate a state machine according to the state machine definition;
instantiate at least one state variable in the memory according to the state variable class definition;
derive a state variable value for the at least one state variable as a function of a first analog signal received via the first analog input;
determine state transition criteria from a current state of the state machine to at least one permitted alternate state of the state machine based on the state variable value and the state machine definition;
construct a decision point discovery message based on the state transition criteria; transmit the decision point discovery message to at least one other state management engine;
receive a discovery response message from the at least one other state management engine, the discovery, response message comprising additional state variable values; and
select a next state from the at least one permitted state as a function of the additional state variable values and the state transition criteria; and cause the state machine to transition from the current state to the next state.

2. The apparatus of claim 1, further comprising a second analog input.

3. The apparatus of claim 2, wherein the state management engine is further programmed to further derive the state variable value as a function of a second analog signal received via the second analog input.

4. The apparatus of claim 1, wherein the communication interface comprises a network interface.

5. The apparatus of claim 4, wherein the network interface includes at least one of the following: an Ethernet interface, a wireless interface, and a cellular interface.

6. The apparatus of claim 1, wherein the state management engine is further programmed to transmit the decision point discovery message via the communication interface and external to the apparatus, to the at least one other state management engine.

7. The apparatus of claim 1, wherein the state machine definition includes state-specific event criteria.

8. The apparatus of claim 7, wherein the state management engine is further configured to transmit an event notification as a function of the state-specific event criteria.

9. The apparatus of claim 1, wherein the at least one other state management engine comprises a second state management engine disposed in the apparatus.

10. The apparatus of claim 1, further comprising at least one analog output.

11. The apparatus of claim 1, further comprising at least two analog outputs.

12. The apparatus of claim 1, further comprising a relay output.

13. The apparatus of claim 1, wherein the state variable value comprises a representation of ambient data.

14. The apparatus of claim 1, wherein the decision point discovery message comprises a contract discovery.

15. The apparatus of claim 14, wherein the discovery response message further comprises a contract.

16. The apparatus of claim 15, further comprising a contract enforcement engine programmed to authorize the state management engine and the at least one other management engine to engage according to their respective contracts.

17. The apparatus of claim 16, wherein the contract enforcement engine is disposed within the apparatus.

18. The apparatus of claim 1, wherein the discovery response message comprises a discovery redirect message.

19. The apparatus of claim 18, wherein the discovery response message includes an identifier of an internal data source of the apparatus.

20. The apparatus of claim 1, wherein the discovery response message further comprises at least one of the following: a second state variable value, an SNMP MIB, a register, a digital value of the analog signal, and a file in the memory.

21. The apparatus of claim 1, wherein the discovery response message further comprises a decision point identifier.

22. The apparatus of claim 21, wherein the decision point identifier designates a state transition decision arbitrator.

23. The apparatus of claim 22, wherein the decision point identifier designates a migrateable state transition arbitrator.

24. The apparatus of claim 22, wherein the state management engine is further programmed to receive the additional state variable values from the state transition decision arbitrator.
